(19) United States
(12) Patent Application Publication
(10) Pub. No.: US 2026/0042458 A1
(43) Pub. Date: Feb. 12, 2026

(54) SYSTEMS AND METHODS FOR REDUCING PLANNING HORIZONS FOR AN AUTONOMOUS VEHICLE WITH GAP CONSTRAINTS

(71) Applicant: Torc Robotics, Inc., Blacksburg, VA (US)

(72) Inventor: Rikki Valverde, Bala Cynwyd, PA (US)

(21) Appl. No.: 18/796,648

(22) Filed: Aug. 7, 2024

(51) Int. Cl. B60W 60/00; B60W 30/18

(52) U.S. Cl. CPC B60W 60/001; B60W 30/18163; B60W 2555/00

(57) ABSTRACT

A computer-implemented method for controlling an autonomous vehicle is provided. The computer-implemented method includes identifying, using a gap planning module, based on a first set of perception data using a first time horizon, a gap an adjacent lane to a lane of travel of the autonomous vehicle, the adjacent lane suitable for entry by the autonomous vehicle. The computer-implemented method further includes generating, using the gap planning module, one or more planning constraints based on the identified gap. The computer-implemented method further includes generating, using a path planning module, a path for the autonomous vehicle based on a second set of perception data, a second time horizon, and the one or more planning constraints. The computer-implemented method further includes controlling the autonomous vehicle based on the generated path.

### TECHNICAL FIELD

The field of the disclosure relates generally to autonomous vehicles and, more specifically, to planning systems for autonomous vehicles.

### BACKGROUND OF THE INVENTION

Autonomous vehicles occasionally need to quickly change lanes, such as when lost cargo or other debris is blocking a lane. To determine where to move, autonomous vehicles generally utilize a path planner that considers different possible paths determined based on perception data, such as sensor data or data derived therefrom. Using this process to identify a gap in an adjacent lane is computationally expensive and may be difficult to complete before an autonomous vehicle reaches a lane obstruction and has to stop. Extending a planning horizon may help in successfully identifying a gap, but results in an exponentially greater need for processing power to successfully plan a path as the length of the planning horizon is increased. An improved system for gap planning for an autonomous vehicle is therefore desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a computer-implemented method for controlling an autonomous vehicle is provided. The computer-implemented method includes identifying, using a gap planning module, based on a first set of perception data using a first time horizon, a gap in an adjacent lane to a lane of travel of the autonomous vehicle, the adjacent lane suitable for entry by the autonomous vehicle. The computer-implemented method further includes generating, using the gap planning module, one or more planning constraints based on the identified gap. The computer-implemented method further includes generating, using a path planning module, a path for the autonomous vehicle based on a second set of perception data, a second time horizon, and the one or more planning constraints. The computer-implemented method further includes controlling the autonomous vehicle based on the generated path.

In another aspect, an autonomy system for an autonomous vehicle is provided. The autonomy system includes a gap planning module configured to identify, based on a first set of perception data using a first time horizon, a gap in an adjacent lane to a lane of travel of the autonomous vehicle, the adjacent lane suitable for entry by the autonomous vehicle, and generate one or more planning constraints based on the identified gap. The autonomy system further includes a path planning module configured to generate a path for the autonomous vehicle based on a second set of perception data, a second time horizon, and the one or more planning constraints, wherein the autonomous vehicle is controlled based on the generated path.

In yet another aspect, an autonomous vehicle is provided. The autonomous vehicle includes a perception system configured to generate perception data. The autonomous vehicle further includes an autonomy system. The autonomy system includes a gap planning module configured to identify, based on a first set of perception data using a first time horizon, a gap in an adjacent lane to a lane of travel of the autonomous vehicle, the adjacent lane suitable for entry by the autonomous vehicle, and generate one or more planning constraints based on the identified gap. The autonomy system further includes a path planning module configured to generate a path for the autonomous vehicle based on a second set of perception data, a second time horizon, and the one or more planning constraints, wherein the autonomous vehicle is controlled based on the generated path.

Various refinements exist of the features noted in relation to the above-mentioned aspects. Further features may also be incorporated in the above-mentioned aspects as well.

These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3 is a diagram illustrating an example scenario in which an autonomous vehicle performs a gap alignment operation;

FIG. 4 is a graph illustrating a velocity over time of the autonomous vehicle in the scenario shown in FIG. 3;

FIG. 5 is a flow chart illustrating an example method for controlling an autonomous vehicle; and

FIG. 6 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

The embodiments described herein include an autonomy system for an autonomous vehicle. The autonomy system includes a set of modules that generate respective outputs based on respective inputs and rules. An example input to the modules, referred to herein as “perception data,” includes information perceived by the autonomy system based on sensor data such as of roads, road markings, signs and signals, other vehicles, road obstacles, or other objects relative to autonomous vehicle. These modules include a gap planning module and a path planning module.

The gap planning module is configured to identify, based on a first set of perception data using a first time horizon, a gap in an adjacent lane to a lane of travel of the autonomous vehicle that is suitable for entry by the autonomous vehicle (e.g., there is enough space between vehicles) and to generate one or more planning constraints based on the identified gap. The path planning module configured to generate a path for the autonomous vehicle based on a second set of perception data, a second time horizon, and the one or more planning constraints. The gap planning module may be executed when a need to change lanes is identified (e.g., if there is a blockage in a lane of travel of the autonomous vehicle). In some cases, this need may be outside the normal planning horizon of the path planning module, and therefore may be identified by the gap planning module or another strategic planning module having a longer planning horizon than the path planning module. The gap planning module may then identify a gap in the adjacent lane and generate planning constraints for path planning module. The path planning module then may generate a path that complies with these planning constraints by causing the autonomous vehicle to move into the identified gap. The autonomous vehicle can then be controlled based on the path generated by the path planning module.

Because the path planning module, as compared to the gap planning module, must generate a more complex output (i.e., a path rather than constraints) based on a larger set of perception data and path options, the time horizon used by the path planning module may be shorter (e.g., fifteen seconds or less) than the time horizon used by the gap planning module (e.g., thirty seconds or longer). This increases the chance that the path planning module successfully generates a path meeting any identified constraints, while providing the gap planning module sufficient time to identify a gap into which the autonomous vehicle can move to change lanes.

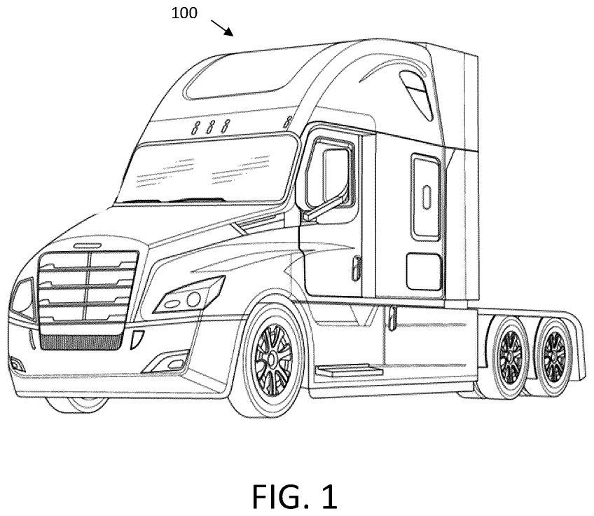

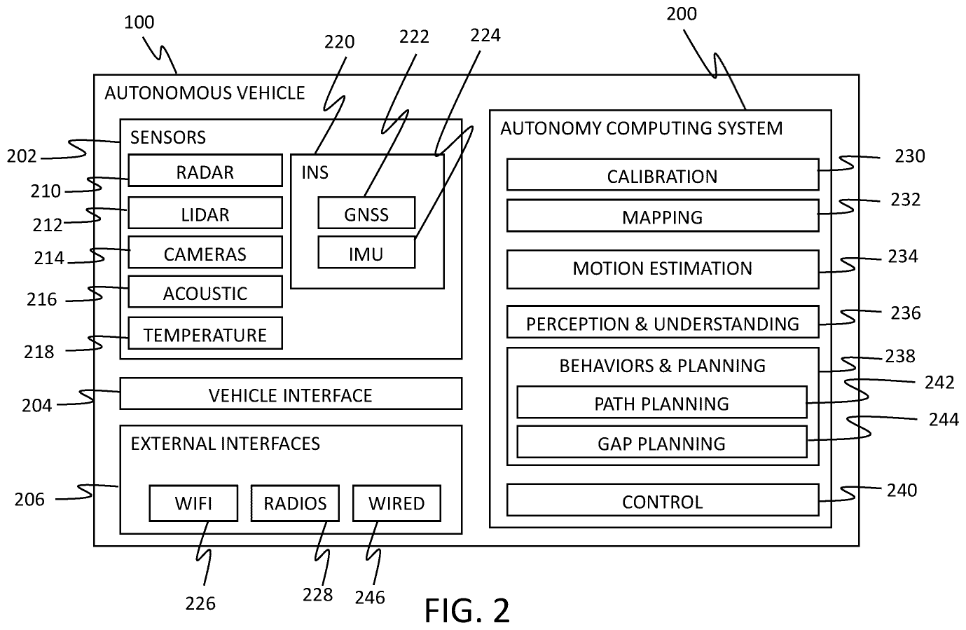

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras' FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 246, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, a path planning module 24, and a gap planning module 244. Path planning module 242 and gap planning module 244, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Perception and understanding module 236 is configured to generate data, referred to herein as perception data, based on data received from sensors 202. Sensors 202 and perception and understanding module 236 are sometimes collectively referred to herein as a “perception system.” This perception data generated by the perception system may include for example, perceived locations of roads, road markings, signs and signals, other vehicles, road obstacles, or other objects relative to autonomous vehicle 100. As described in further detail below, this perception data is utilized by path planning module 242 and gap planning module 244 to generate a path for autonomous vehicle to follow. Controller 240 then uses this generated path to generate control operations and control various components of autonomous vehicle 100.

Path planning module 242 uses a set of perception data, which in some cases may include substantially all of the perception data generated by perception and understanding module 236, to generate a path for autonomous vehicle 100 by applying the perception data to predefined sets of rules and criteria. Path planning module 242 continually updates this path based on new perception data. The path generated by path planning module 242 is defined over a time period extending from a present time to a certain time in the future relative to the present time, referred to as a time horizon. Generally, a longer time horizon enables path planning module 242 to generate a more optimal path; however, the computational power needed to generate the path increases exponentially as the time horizon increases. Thus, the time horizon utilized by path planning module 242 may be selected to provide an adequate path (i.e., a path that does not result in collisions and complies with traffic rules to the extent possible) without utilizing more computing power than necessary to achieve an adequate path. For example, in some embodiments, the time horizon time horizon utilized by path planning module 242 is less than or equal to fifteen seconds.

In certain situations, path planning module 242 may determine to merge into a lane adjacent to a lane of travel of autonomous vehicle 100. For example, the lane of travel may be ending or blocked, or it may be necessary to move to another lane to follow a planned route. In such situations, an execution of gap planning module 244 is triggered to identify a gap in traffic in the adjacent lane into which autonomous vehicle 100 can merge.

Gap planning module 244 uses another set of perception data, which is some cases may be a subset of the perception data utilized by path planning module 242. Using this set of perception data, gap planning module 244 is configured to identify a gap in an adjacent lane that is suitable for entry by autonomous vehicle 100 and communicate the gap to path planning module 242, such as by generating one or more planning constraints for path planning module 242. In some embodiments, these constraints define an area relative to autonomous vehicle 100, and path planning module 242 is configured to generate a path that enters the area defined by the one or more planning constraints. Once autonomous vehicle 100 has successfully changes lanes, operation of gap planning module 244 may cease until another lane change operation is demanded.

Because gap planning module 244 utilizes different criteria for identifying a gap than is considered by path planning module 242, in some cases, gap planning module is capable of identifying gaps that would not be identified by path planning module 242. For example, even if there are no gaps present that would fit autonomous vehicle 100, gap planning module 244 may still identify a “best” gap, such as a gap that is more likely to eventually open to a size suitable for autonomous vehicle 100 (e.g., if autonomous vehicle 100 were to use turn signals to encourage another vehicle to let autonomous vehicle 100 into the lane).

In some cases, identifying a gap requires a longer time horizon to complete successfully than other planning operations. For this reason, gap planning module 244 uses a time horizon that may be different than the time horizon used by path planning module 242. For example, gap planning module 244 may utilize a longer time horizon, such a has a time horizon of thirty seconds or greater. Because gap planning module 244 may use a smaller set of perception data and generates constraints rather than a path, gap planning module 244 may require relatively little computing power, thereby enabling a longer time horizon to be used for gap planning.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

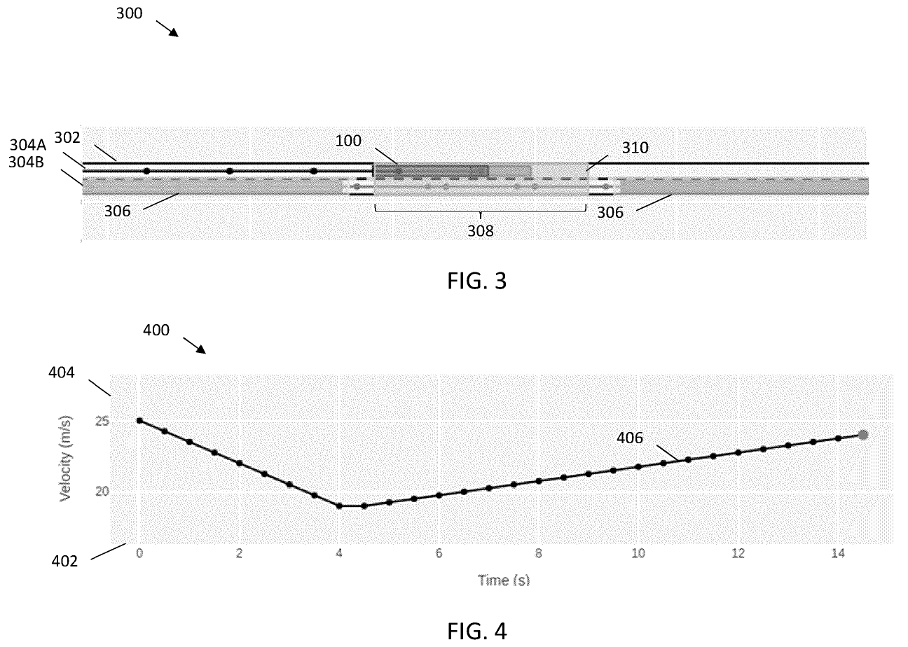

FIG. 3 is a diagram of an example scenario 300 in which autonomous vehicle 100 performs a gag alignment operation using autonomy computing system 200. In scenario 300, autonomous vehicle 100 travels down a road 302 having a first or initial lane 304A and a second or target lane 304B. Autonomous vehicle 100 initially travels in initial lane 304A and, using gap planning module 242 or another strategic planning module, determines to merge into target lane 304B. For example, a need to change lanes may arise outside of the normal planning horizon of path planning module 244. Obstructions 306, such as other vehicles, are present in target lane 304B, necessitating that autonomous vehicle 100 identify a gap in target lane 304B into which autonomous vehicle 100 can safely merge. Autonomous vehicle 100 then executes gap planning module 244 which, based on perception data, identifies a gap 308 into which autonomous vehicle can merge. Gap planning module 244 generates planning constraints 310 (e.g., an area including gap 308) for path planning module 242 to consider in generating a path utilizing gap 308. Path planning module 242 then generates a path, which may be used by autonomous vehicle 100 to align with the gap in preparation for a merge into target lane 304B.

FIG. 4 is a graph 400 illustrating a velocity of autonomous vehicle 100 during scenario 300. Graph 400 includes a horizontal axis 402 representing time expressed in seconds and a vertical axis 404 representing velocity with respect to road 302 represented in meters per second. Graph 400 further includes a curve 406 representing a velocity of autonomous vehicle 100 over time. As illustrated by curve 406, in a situation in which autonomous vehicle 100 is initially traveling ahead of gap 308, autonomous vehicle 100 may decelerate until autonomous vehicle is alongside gap 308, at which point autonomous vehicle 100 may maintain a velocity constant with gap 308 and/or accelerate before merging into target lane 304B.

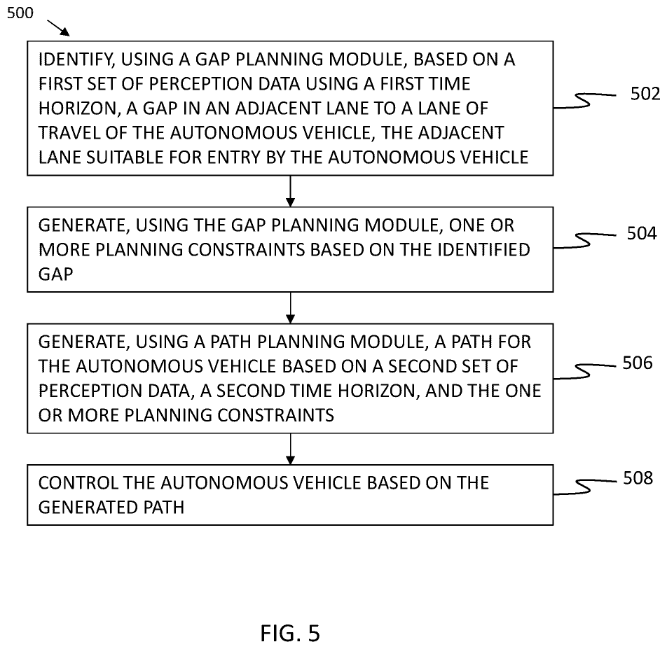

FIG. 5 is a flowchart illustrating an example method 500 for controlling autonomous vehicle 100 (shown in FIG. 1). In the example embodiment, method 500 is performed by autonomy computing system 200 (shown in FIG. 2). Autonomy computing system 200 identifies 502, using a gap planning module 244, based on a first set of perception data using a first time horizon, a gap in an adjacent lane to a lane of travel of autonomous vehicle 100 and suitable for entry by autonomous vehicle 100. The first set of perception data includes perception data specifically needed for identifying gaps, such as locations of vehicles or other obstructions in the adjacent lane relative to autonomous vehicle 100.

Autonomy computing system 200 generates 504, using gap planning module 244, one or more planning constraints (such as planning constraints 310) based on the identified gap. These planning constraints define limitations on where path planning module 242 can plan a path. For example, the planning constraints may require that the path must lead into the identified gap. Autonomy computing system 200 generates 506, using path planning module 242, a path for autonomous vehicle 100 based on a second set of perception data, a second time horizon, and the one or more planning constraints. The second set of perception data includes perception data needed for path planning, which may include any of the types of perception data described herein in addition to the perception data utilized for gap planning, and therefore generally includes a larger set of data than the first set of data. Autonomy computing system 200 controls 508 autonomous vehicle 100 based on the generated path. For example, autonomous vehicle 100 is controlled to follow the generated path.

In certain embodiments, the first time horizon is longer than the second time horizon. For example, in certain such embodiments, the first time horizon is greater than or equal to thirty seconds, and the second time horizon is less than or equal to fifteen seconds.

In some embodiments, autonomy computing system 200 controls autonomous vehicle 100 to follow the generated path.

In certain embodiments, the second set of perception data includes at least the first set of perception data.

In some embodiments, the one or more planning constraints define an area (such as that illustrated by planning constraints 310 shown in FIG. 3) relative to autonomous vehicle 100. For example, the area may include a portion of the adjacent lane expected to have no obstructions, as indicated by the identified gap, at a time autonomous vehicle 100 is able to move adjacent to and/or into the portion. In some such embodiments, the path generated by path planning module 242 leads into area defined by the one or more planning constraints.

In certain embodiments, method 500 further includes determining, by path planning module 242, based on the second set of perception data, to plan a lane change and trigger execution of the gap planning module while planning the lane change.

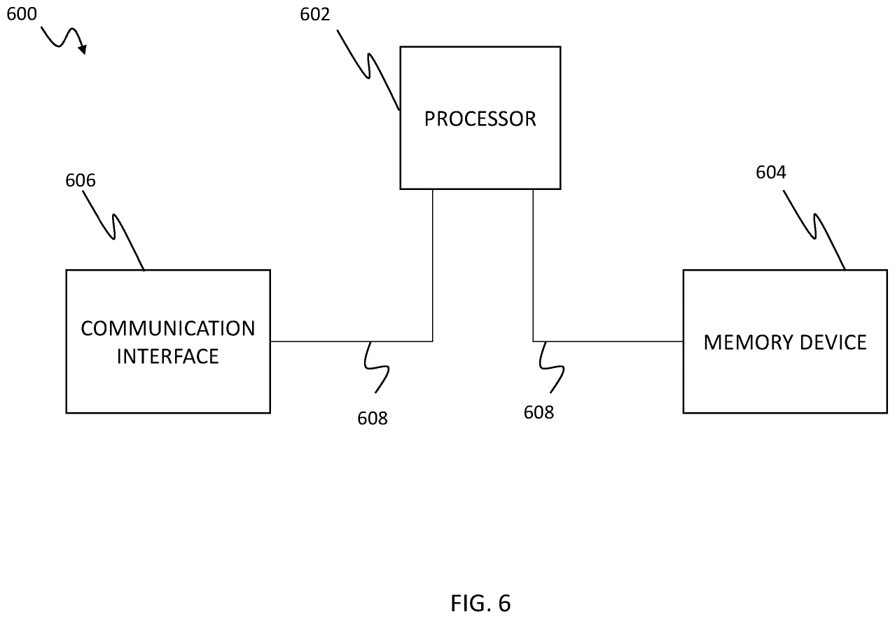

FIG. 6 is a block diagram of an example computing device 600. Systems and methods described herein may be implemented with one or more computing devices 600. Computing device 600 includes a processor 602 and a memory device 604. The processor 602 is coupled to the memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 604 includes one or more devices that enable information, such as executable instructions or other data (e.g., sensor data), to be stored and retrieved. Moreover, the memory device 604 includes one or more computer readable media, such as, without limitation, dynamic random access memory (DRAM), static random access memory (SRAM), a solid state disk, or a hard disk. In the example embodiment, the memory device 604 stores, without limitation, application source code, application object code, configuration data, additional input events, application states, assertion statements, validation results, or any other type of data. The computing device 600, in the example embodiment, may also include a communication interface 606 that is coupled to the processor 602 via system bus 608. Moreover, the communication interface 606 is communicatively coupled to data acquisition devices.

In the example embodiment, processor 602 may be programmed by encoding an operation using one or more executable instructions and providing the executable instructions in the memory device 604. In the example embodiment, the processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) ability to provide a shorter time horizon for path planning by an autonomous vehicle by utilizing a separate module for gap planning that generates planning constraints for path planning using a longer time horizon or (b) reducing a computational load necessary for path planning by utilizing a separate module for gap planning that generates path planning constraints using a specific set of perception data relating to gap identification.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A computer-implemented method for controlling an autonomous vehicle, the computer-implemented method comprising:
identifying, using a gap planning module, based on a first set of perception data using a first time horizon, a gap in an adjacent lane to a lane of travel of the autonomous vehicle, the adjacent lane suitable for entry by the autonomous vehicle;
generating, using the gap planning module, one or more planning constraints based on the identified gap;
generating, using a path planning module, a path for the autonomous vehicle based on a second set of perception data, a second time horizon, and the one or more planning constraints; and
controlling the autonomous vehicle based on the generated path.

2. The computer-implemented method of claim 1, wherein the first time horizon is longer than the second time horizon.

3. The computer-implemented method of claim 1, further comprising controlling the autonomous vehicle to follow the generated path.

4. The computer-implemented method of claim 1, wherein the second set of perception data includes at least the first set of perception data.

5. The computer-implemented method of claim 1, wherein the one or more planning constraints define an area relative to the autonomous vehicle.

6. The computer-implemented method of claim 5, wherein the path generated by the path planning module leads into the area defined by the one or more planning constraints.

7. The computer-implemented method of claim 1, further comprising:
determining, using the path planning module, based on the second set of perception data, to plan a lane change; and
triggering, using the path planning module, execution of the gap planning module while planning the lane change.

8. An autonomy system for an autonomous vehicle, the autonomy system comprising:
a gap planning module, the gap planning module configured to:
identify, based on a first set of perception data using a first time horizon, a gap in an adjacent lane to a lane of travel of the autonomous vehicle, the adjacent lane suitable for entry by the autonomous vehicle; and
generate one or more planning constraints based on the identified gap; and
a path planning module configured to generate a path for the autonomous vehicle based on a second set of perception data, a second time horizon, and the one or more planning constraints, wherein the autonomous vehicle is controlled based on the generated path.

9. The autonomy system of claim 8, wherein the first time horizon is longer than the second time horizon.

10. The autonomy system of claim 8, further comprising a controller configured to control the autonomous vehicle to follow the generated path.

11. The autonomy system of claim 8, wherein the second set of perception data includes at least the first set of perception data.

12. The autonomy system of claim 8, wherein the one or more planning constraints define an area relative to the autonomous vehicle.

13. The autonomy system of claim 12, wherein the path generated by the path planning module leads into the area defined by the one or more planning constraints.

14. The autonomy system of claim 8, wherein the path planning module is further configured to:
determine, based on the second set of perception data, to plan a lane change; and
trigger execution of the gap planning module while planning the lane change.

15. The autonomy system of claim 9, further comprising a control module configured to control the autonomous vehicle based on the generated path.

16. An autonomous vehicle comprising:
a perception system configured to generate perception data; and
an autonomy system comprising:
a gap planning module, the gap planning module configured to:
identify, based on a first set of perception data using a first time horizon, a gap in an adjacent lane to a lane of travel of the autonomous vehicle, the adjacent lane suitable for entry by the autonomous vehicle; and
generate one or more planning constraints based on the identified gap; and
a path planning module configured to generate a path for the autonomous vehicle based on a second set of perception data, a second time horizon, and the one or more planning constraints, wherein the autonomous vehicle is controlled based on the generated path.

17. The autonomous vehicle of claim 16, wherein the first time horizon is longer than the second time horizon.

18. The autonomous vehicle of claim 16, wherein the second set of perception data includes at least the first set of perception data.

19. The autonomous vehicle of claim 16, wherein the one or more planning constraints define an area relative to the autonomous vehicle.

20. The autonomous vehicle of claim 19, wherein the path generated by the path planning module leads into the area defined by the one or more planning constraints.
